(19) United States
(12) Patent Application Publication
(10) Pub. No.: US 2018/0196919 A1
(43) Pub. Date: Jul. 12, 2018

(54) AUTOMATED HEALTH DIALOGUING AND ACTION ENHANCEMENT

(71) Applicant: International Business Machines Corporation, Armonk, NY (US)

(72) Inventors: Alaa ABOU MAHMOUD, Dracut, MA (US); Paul R. BASTIDE, Boxford, MA (US); Fang LU, Billerica, MA (US)

(21) Appl. No.: 15/402,338

(22) Filed: Jan. 10, 2017

(51) Int. Cl. G06F 19/00; G10L 25/66

(52) U.S. Cl. CPC G06F 19/322; H04L 67/42; G10L 25/66; G06F 19/345

(57) ABSTRACT

A server analyzes data from interactions between the user and an automated response system to form a speech pattern history for the user. The server analyzes data from a current interaction to identify a current speech pattern of the user and compares the current speech pattern with the speech pattern history. Responsive to determining that the comparison exceeds a first predetermined threshold, the server sends additional dialog prompt(s) to be issued by the automated response system. The server analyzes data from an extended interaction between the user and the automated response system to identify an extended speech pattern of the user and compares the extended speech pattern with the speech pattern history of the user. Responsive to determining that the comparison exceeds a second predetermined threshold, the server matches the extended speech pattern to a potential health condition and determines an action associated with the potential health condition.

### BACKGROUND

Untreated health issues contribute to the rise in healthcare costs and absenteeism-related productivity losses for employers. Research has shown that education, intervention, and action produce better health outcomes. Many client devices include an automated response system, such as Siri™, which uses speech analysis to interact with the user. However, the dialogs offered by the automated response systems are limited to a topic identified by the user and are not leveraged for other purposes to benefit the user.

### SUMMARY

Disclosed herein is a method for analyzing speech patterns to identify an action associated with a health condition, and a computer program product as specified in the independent claims. Embodiments of the present invention are given in the dependent claims. Embodiments of the present invention can be freely combined with each other, if they are not mutually exclusive.

According to an embodiment of the present invention, a server analyzes data from interactions between the user and an automated response system to form a speech pattern history for the user. The server analyzes data from a current interaction to identify a current speech pattern of the user and compares the current speech pattern with the speech pattern history. Responsive to determining that the comparison exceeds a first predetermined threshold, the server sends additional dialog prompt(s) to be issued by the automated response system. The server analyzes data from an extended interaction between the user and the automated response system to identify an extended speech pattern of the user and compares the extended speech pattern with the speech pattern history of the user. Responsive to determining that the comparison exceeds a second predetermined threshold, the server matches the extended speech pattern to a potential health condition and determines an action associated with the potential health condition.

### BRIEF DESCRIPTION OF THE DRAWINGS

FIG. 1 illustrates a system for analyzing speech patterns to identify an action associated with a health condition, according to embodiments of the present invention.

FIG. 2 illustrates a method for analyzing speech patterns to identify an action associated with a health condition, according to embodiments of the present invention.

FIG. 3 illustrates a computer system for implementing a method for analyzing speech patterns to identify an action associated with a health condition, according to embodiments of the present invention.

### DETAILED DESCRIPTION

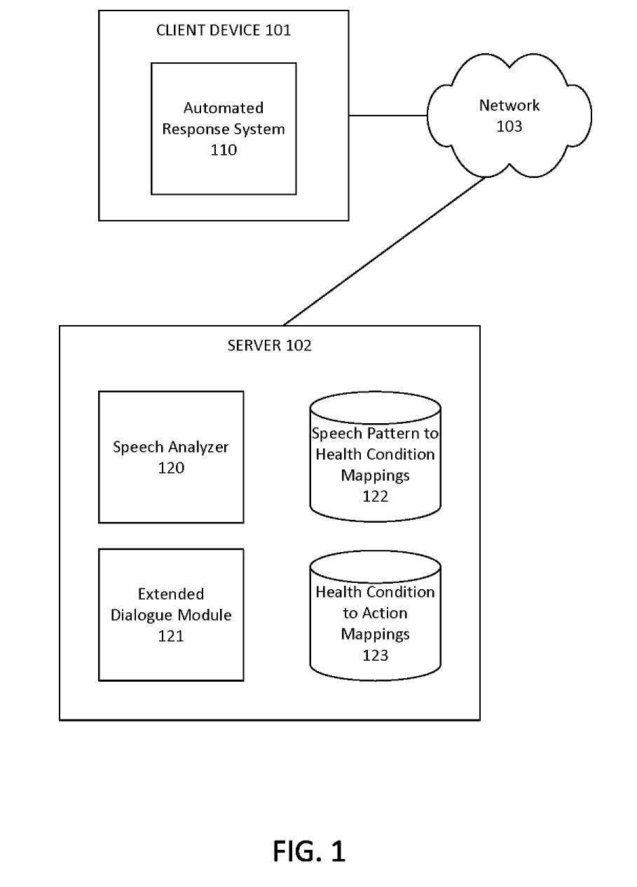

FIG. 1 illustrates a system for analyzing speech patterns to identify an action associated with a health condition, according to embodiments of the present invention. The system includes a client device 101 in communication with a server 102 over a data network 103. The client device 101 includes an automated response system 110, with which a user may interact using natural speech. The server 102 includes a speech analyzer 120 for analyzing user speech patterns captured via the automate response system 110. The server 102 further includes an extended dialogue module 121, a storage storing speech pattern to health condition mappings 122, and another storage storing health condition to action mappings 123. The extended dialogue module 121, the speech pattern to health condition mappings 122, and the health condition to action mappings 123 are described further below. Exemplary embodiments of the present invention augment automated response systems 110 at client devices 101 and speech analyzers 120 at servers 102. Alternatively, one or more components or modules at the server 102 may be implemented at the client device 101.

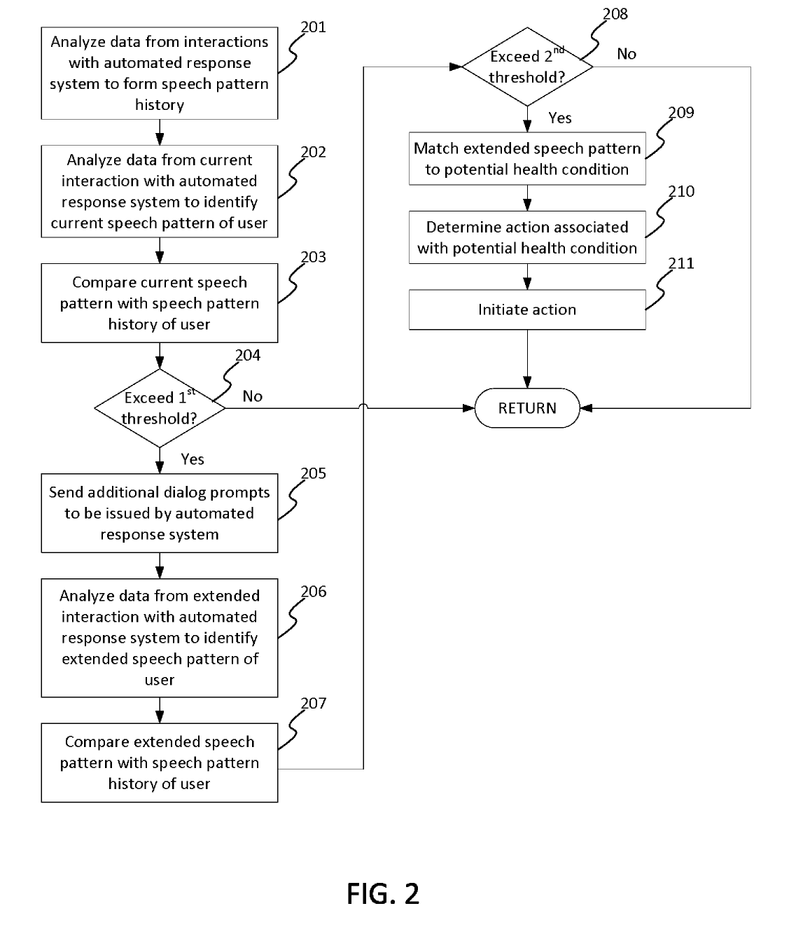

FIG. 2 illustrates a method for analyzing speech patterns to identify an action associated with a health condition, according to embodiments of the present invention. With reference to both FIGS. 1 and 2, as a user interacts with the automated response system 110 at the client device 101 using natural speech, the speech of the user during the interactions are captured by the automated response system 110, and speech data is sent to the server 102 for analysis. The speech analyzer 120 at the server 102 analyzes the data and identifies the speech patterns of the user during the interactions between the user and the automated response system 110 to form speech pattern history of the user (201). During a current interaction, the speech analyzer 120 analyzes data from the current interaction between the user and the automated response system 110 and identifies a current speech pattern of the user (202). The extended dialogue module 121 compares the current speech pattern with the speech pattern history of the user (203). The current speech pattern is also integrated into the speech pattern history of the user as part of a feedback loop to optimize the speech pattern history. From the comparison, extended dialogue module 121 determines whether the comparison exceeds a first predetermined threshold (204). In an exemplary embodiment, the speech analyzer 120 analyzes the current speech pattern for speech abnormalities for the user, such as slower than normal speech speed, a lower pitch, a cough, or pauses over a certain length, or pauses where a natural pause is not typical for the user. The extended dialogue module 121 calculates a first total score based on a value assigned to each speech abnormality for the user. The first total score represents a likelihood of a health condition. The first total score is then compared with the first predetermined threshold. When the comparison exceeds the first predetermined threshold, the extended dialogue module 121 sends additional dialog prompts to the client device 101 to be issued by the automated response system 110 (205). The additional dialog prompts may be selected from a list of preset patterns or from a history of conversations between the user and the automated response system 110.

The automated response system 110 issues the additional dialog prompts, captures the user's speech during the extended interaction between the user and the automated response system 110, and sends the speech data to the server 102. The speech analyzer 120 analyzes the data and identifies an extended speech pattern of the user (206) and compares the extended speech pattern with the speech pattern history of the user (207). From the comparison, extended dialogue module 121 determines whether the comparison exceeds a second predetermined threshold (208). In an exemplary embodiment, the speech analyzer 120 analyzes the extended speech pattern for speech abnormalities for the user, in a similar manner as for the current speech pattern, described above. In an exemplary embodiment, the extended dialogue module 121 calculates a second total score based on a value assigned to each speech abnormality for the user, in a manner similar to the first total score, described above. The second total score is compared with the first total score to determine a delta, and the delta is compared with the second predetermined threshold. The delta represents a level of confirmation of a potential health condition. In an exemplary embodiment, the delta may show a downward trend from the first total score to the second total score, representing a decrease in the likelihood of a potential health condition, in which case, the extended dialogue module 121 may take no further action and resets the process. The delta may show a similar or an upward trend from the first total score to the second total score, representing a confirmation or an increased likelihood of a potential health condition. When the comparison (e.g. the delta) exceeds the second predetermined threshold, the extended dialogue module 121, using the speech pattern to health condition mappings 122, matches the abnormalities in the extended speech pattern to a potential health condition (209). In an exemplary embodiment, the extended dialogue module 121 matches an identified “cough”, “pitch”, “slower”, “pause”, or some combination thereof, to a health condition. The extended dialogue module 121 then, using the health condition to action mappings 123, determines an action associated with the potential health condition (210).

The action can then be initiated (211), either by the server 102, the client device 101, or as a suggested action to be initiated by the user. Example actions include, but are not limited to: prompt for user to schedule a doctor's appointment; prompt to user to visit an urgent care center; prompt for a medical device usage; routing the user to a local urgent care center, such as via a mapping application; accessing a contacts application on the client device 101 to contact a health professional; and action via integration with an advanced health dialogue agent. Access to a current location of the client device 101 via a global positioning unit (GPS) coupled to the client device 101, and/or a current time, may be used to assist in any of the actions. In one exemplary embodiment, a default action may be configured for any health condition without a predetermined mapping to an action.

In an exemplary embodiment, the user is given an option to opt-in or opt-out of the extended interaction. The extended dialogue module 121 may be configured such that when the user opts-out of the extended interaction, the module 121 may gather speech patterns of the user across multiple interactions and use these multiple speech patterns to calculate the second total score. A time span within which interactions will be used for the calculation may be configured based on the level of accuracy desired. Optionally, the extended dialogue module 121 may be configured to determine whether the speech pattern data from a particular interaction is sufficient to calculate the second total score, and when insufficient, use speech patterns across multiple interactions to calculate the second total score.

Consider the following example scenario, with reference to FIGS. 1 and 2. Alice is a user of the client device 101 and has configured her automated response system 110 with her speech pattern history via interactions with the automated response system 110 (201). In a current interaction, Alice asks the automated response system 110, “What's [nasal sound] the weather [pause] today? [cough]”. Alice's speech data is captured by the automated response system 110 and sent to the speech analyzer 120. The speech analyzer 120 analyzes the speech data, identifies Alice's current speech pattern (202), and compares the current speech pattern to Alice's speech pattern history (203). Assume in this example that the speech analyzer 120 identifies a “nasal sound”, “pause”, and “cough” as abnormalities for Alice and that these abnormalities resulted in a first total score that exceeds the first predetermined threshold (204). The extended dialogue module 121 then selects and sends additional dialog prompts to the client device 110 to be issued by the automated response system 110 (205). The extended dialogue module 121 may select a non-user-specific dialogue prompt, such as “Please repeat your question”, or search a history of interactions with Alice to select a user-specific dialogue prompt, such as “The weather today is nice and warm. Do you want to search for a current stock price?” Assume that the extended dialogue module 121 selects, “Please repeat your question”. During the extended interaction, Alice answers, “What's the weather [cough] today?” Alice's speech data from the extended interaction is captured by the automated response system 110 and sent to the speech analyzer 120. The speech analyzer 120 analyzes the speech data, identifies Alice's extended speech pattern (206) and compares it with Alice's speech pattern history (207). Assume in this example that the speech analyzer 120 identifies further abnormalities which result in a second total score, where the delta between the first and second total scores exceeds the second predetermines threshold (208), confirming a potential health condition. The extended dialogue module 121 maps Alice's abnormalities in her extended speech pattern to a given potential health condition (209), and maps the given potential health condition to an action to direct Alice to the nearest local clinic (210). To initiate the action (211), for example, the extended dialogue module 121 may send a command to the client device 101 to obtain the client device's current location, such as via a GPS module coupled to the client device 101. The extended dialogue module 121 may then determines the nearest clinic from the client device's current location and sends a command to a mapping application at the client device 101 to direct Alice to the clinic.

In the manner described above, embodiments of the present invention leverages automated response systems to identify and confirm the existence of a user's potential health condition, so that a course of action may be taken.

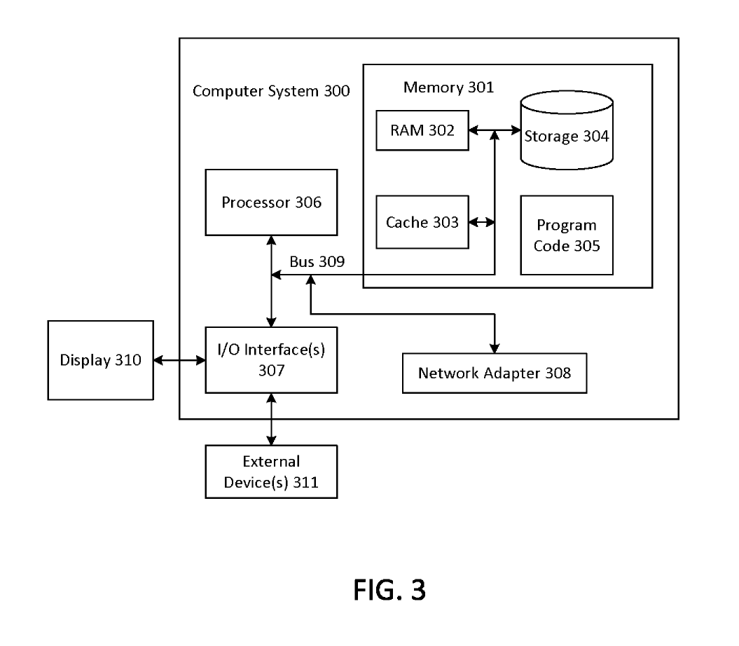

FIG. 3 illustrates a computer system for implementing a method for analyzing speech patterns to identify an action associated with a health condition, according to embodiments of the present invention. The computer system may be implemented as the client device 101 and/or the server 102. The computer system 300 is operationally coupled to a processor or processing units 306, a memory 301, and a bus 309 that couples various system components, including the memory 301 to the processor 306. The bus 309 represents one or more of any of several types of bus structure, including a memory bus or memory controller, a peripheral bus, an accelerated graphics port, and a processor or local bus using any of a variety of bus architectures. The memory 301 may include computer readable media in the form of volatile memory, such as random access memory (RAM) 302 or cache memory 303, or non-volatile storage media 304. The memory 301 may include at least one program product having a set of at least one program code module 305 that are configured to carry out the functions of embodiment of the present invention when executed by the processor 306. The computer system 300 may also communicate with one or more external devices 311, such as a display 310, via I/O interfaces 307. The computer system 300 may communicate with one or more networks via network adapter 308.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for analyzing speech patterns to identify an action associated with a health condition, comprising:
analyzing, by a server, data from a current interaction between a user and an automated response system to identify a current speech pattern of the user;
comparing the current speech pattern with a speech pattern history of the user by the server;
responsive to determining that the comparison of the current speech pattern and the speech pattern history exceeds a first predetermined threshold, sending, by the server, one or more additional dialog prompts to be issued by the automated response system;
analyzing, by the server, data from an extended interaction between the user and the automated response system to identify an extended speech pattern of the user;
comparing the extended speech pattern of the user with the speech pattern history of the user by the server;
responsive to determining that the comparison of the extended speech pattern and the speech pattern history exceeds a second predetermined threshold, matching the extended speech pattern to a potential health condition by the server; and
determining an action associated with the potential health condition by the server.

2. The method of claim 1, wherein the comparing of the current speech pattern with the speech pattern history of the user comprises:
identifying first speech abnormalities for the user in the current speech pattern;
calculating a first total score based on a value assigned to each of the first speech abnormalities for the user; and
comparing the first total score to the first predetermined threshold.

3. The method of claim 1, wherein the sending of the one or more additional dialog prompts to be issued by the automated response system comprises:
selecting the one or more additional dialog prompts based on a dialog history between the user and the automated response system.

4. The method of claim 2, wherein the comparing of the extended speech pattern of the user with the speech pattern history of the user comprises:
identifying second speech abnormalities for the user in the extended speech pattern;
calculating a second total score based on a value assigned to each of the second speech abnormalities for the user;
determining a delta between the second total score and the first total score; and
responsive to determining that the delta exceeds the second predetermined threshold, matching the second speech abnormalities to the potential health condition.

5. The method of claim 1, wherein the action associated with the potential health condition is to be initiated by the server or by a client device coupled to the automated response system.

6. The method of claim 1, further comprising:
determining a current location of the user or a current time; and
determining the action based on the potential health condition and either the current location or the current time.

7. The method of claim 1, further comprising:
analyzing, by a server, data from interactions between the user and the automated response system to form the speech pattern history for the user;

8. A computer program product for analyzing speech patterns to identify an action associated with a health condition, the computer program product comprising a computer readable storage medium having program instructions embodied therewith, the program instructions executable by a processor to cause the processor to:
analyze data from a current interaction between a user and an automated response system to identify a current speech pattern of the user;
compare the current speech pattern with a speech pattern history of the user;
responsive to determining that the comparison of the current speech pattern and the speech pattern history exceeds a first predetermined threshold, send one or more additional dialog prompts to be issued by the automated response system;
analyze data from an extended interaction between the user and the automated response system to identify an extended speech pattern of the user;
compare the extended speech pattern of the user with the speech pattern history of the user;
responsive to determining that the comparison of the extended speech pattern and the speech pattern history exceeds a second predetermined threshold, match the extended speech pattern to a potential health condition; and
determine an action associated with the potential health condition.

9. The computer program product of claim 8, wherein the compare of the current speech pattern with the speech pattern history of the user comprises:
identify first speech abnormalities for the user in the current speech pattern;
calculate a first total score based on a value assigned to each of the first speech abnormalities for the user; and
compare the first total score to the first predetermined threshold.

10. The computer program product of claim 8, wherein the send of the one or more additional dialog prompts to be issued by the automated response system comprises:
select the one or more additional dialog prompts based on a dialog history between the user and the automated response system.

11. The computer program product of claim 9, wherein the compare of the extended speech pattern of the user with the speech pattern history of the user comprises:
identify second speech abnormalities for the user in the extended speech pattern;
calculate a second total score based on a value assigned to each of the second speech abnormalities for the user;
determine a delta between the second total score and the first total score; and
responsive to determining that the delta exceeds the second predetermined threshold, match the second speech abnormalities to the potential health condition.

12. The computer program product of claim 8, wherein the action associated with the potential health condition is to be initiated by the server or by a client device coupled to the automated response system.

13. The computer program product of claim 8, further comprising:
determine a current location of the user or a current time; and
determine the action based on the potential health condition and either the current location or the current time.

14. The computer program product of claim 8, further comprising:
analyze data from interactions between the user and the automated response system to form the speech pattern history for the user.

15. A system, comprising:
a processor; and
a computer readable storage medium having program instructions embodied therewith, the program instructions executable by the processor to cause the processor to:
analyze data from a current interaction between a user and an automated response system to identify a current speech pattern of the user;
compare the current speech pattern with a speech pattern history of the user;
responsive to determining that the comparison of the current speech pattern and the speech pattern history exceeds a first predetermined threshold, send one or more additional dialog prompts to be issued by the automated response system;
analyze data from an extended interaction between the user and the automated response system to identify an extended speech pattern of the user;
compare the extended speech pattern of the user with the speech pattern history of the user;
responsive to determining that the comparison of the extended speech pattern and the speech pattern history exceeds a second predetermined threshold, match the extended speech pattern to a potential health condition; and
determine an action associated with the potential health condition.

16. The system of claim 15, wherein the compare of the current speech pattern with the speech pattern history of the user comprises:
identify first speech abnormalities for the user in the current speech pattern;
calculate a first total score based on a value assigned to each of the first speech abnormalities for the user; and
compare the first total score to the first predetermined threshold.

17. The system of claim 15, wherein the send of the one or more additional dialog prompts to be issued by the automated response system comprises:
select the one or more additional dialog prompts based on a dialog history between the user and the automated response system.

18. The system of claim 16, wherein the compare of the extended speech pattern of the user with the speech pattern history of the user comprises:
identify second speech abnormalities for the user in the extended speech pattern;
calculate a second total score based on a value assigned to each of the second speech abnormalities for the user;
determine a delta between the second total score and the first total score; and
responsive to determining that the delta exceeds the second predetermined threshold, match the second speech abnormalities to the potential health condition.

19. The system of claim 15, wherein the action associated with the potential health condition is to be initiated by the server and by a client device coupled to the automated response system.

20. The system of claim 15, further comprising:
determine a current location of the user or a current time; and
determine the action based on the potential health condition and either the current location or the current time.
